(19) United States
(12) Patent Application Publication
(10) Pub. No.: US 2007/0270137 A1
(43) Pub. Date: Nov. 22, 2007

(54) SYSTEM AND METHOD FOR PUBLISHING ELECTRONIC CONTENT BETWEEN WIRELESS AND WIRED NETWORKS

(76) Inventors: Chang Feng, Princeton, NJ (US); Timothy Hingston, Emeryville, CA (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/734,038

(22) Filed: Apr. 11, 2007

Related U.S. Application Data
(60) Provisional application No. 60/791,874, filed on Apr. 12, 2006.

(51) Int. Cl. H04L 29/08

(52) U.S. Cl. 455/414.4

(57) ABSTRACT

A system and method for automatically publishing electronic content from a wireless network (i.e., a wireless device) to a wired network, and vice versa. The system and method allows a user to create a publish electronic content (e.g., a video clip) across wired and wireless networks, from a mobile device, such as a mobile phone, to a web destination, and vice versa.

### CROSS REFERENCE TO RELATED APPLICATION

This application claims the benefit of U.S. Provisional Application Ser. No. 60/791,874 filed on Apr. 12, 2006. The entire disclosure of U.S. Provisional Application Ser. No. 60/791,874 is incorporated by reference herein.

### FIELD OF THE INVENTION

The present invention relates generally to the exchange and publishing of content across wireless and wired networks.

### BACKGROUND OF THE INVENTION

Today's IP infrastructure is pervasive and includes a variety of wired and wireless networks. This infrastructure, while vast, is not adapted to efficiently facilitate the exchange of one or more video files between a wired network and a wireless network. One exemplary difficulty frequently faced by users occurs when attempting to delivery a video file recorded on a mobile phone to a web destination. This type of delivery requires the user (i.e., the sender of the video file) to take many manual steps, some of which are technically challenging to the average user. Similarly, to successfully publish a desktop video to a mobile phone platform is also a complicated task, often requiring the execution of sophisticated operations, such as, for example, video transcoding using professional tools.

Additionally, while there are general standards, such as, for example, Multimedia Message Service (MMS), guiding how certain video formats should be delivered, different wireless carriers often impose additional restrictions or establish carrier-specific delivery systems and system requirements. This adds additional barriers impeding an end user's ability to publish video content across these networks.

While MMS platforms allow a wireless device (e.g., a cell phone or personal digital assistant (PDA)) user to send video from his or her phone to another mobile phone or email address, publishing the video to a web destination requires the execution of additional manual steps. For example, the email including the video attachment must be received by a desktop email client associated with the destination website. The desktop email client must then manually save the video file attachment onto a local hard disk, and then manually upload the file onto the destination website.

Furthermore, the method by which the video is delivered by a built-in mechanism such as MMS varies greatly among different wireless service providers. For example, some providers send the video as an email attachment, while others process and store the video file in their own backend and only forward a URL to the intended receiver. As such, these problems discourage the use of leveraging native capability on a mobile device to accomplish the identified task.

In addition, some smart phones (e.g., the Treo 700) support advanced web browsing capability. In this regard, a user may open the mobile browser, go to a web destination containing the desired video content, download the content, and play back the video file(s) on the phone. However, this method requires that the video be published in a format that is supported by the mobile device, which is often not the case.

Other conventional services, such as, for example, MobiTV and V CAST (offered by Verizon Wireless offer pre-encoded video content for provisioning to and from specially-configured mobile devices. This content is generally produced offline using professional tools to meet the technical requirements of the particular mobile device. However, in certain applications, the time delay introduced by such offline processing renders the content of little to no value.

Aside from facing the above-described technical challenges, the additional manual steps mentioned above introduce significantly time delays, which could significantly reduce the value of the video content being delivered, particularly for video content having a value which is greatly dependent on the timeliness of its publishing. Such content includes, for example, news content, real-time and/or near real-time content, and other similar just-in-time type of information.

Many video content services associate their commercial success with the number of users they attract. For example, blogging sites are typically rated based on the amount of traffic on the site (i.e., the number of hits the website receives). As such, a clear advantage in the art would be gained by the implementation of an efficient publishing system and method, which would enable users to interface with websites more freely and easily. The complicated technical processing steps required by many conventional publishing systems fail to provide users with this ability.

Furthermore, while conventional systems and methods have tried to implement standalone software and install them on the mobile phones to give the publishing service better control on the overall workflow, this solution depends on the specific carrier. Publishing and distributing standalone software to a mobile platform is often a difficult, long dragged out process which prohibits most commercial entities from adopting this approach.

Accordingly, thee is a need in the art for a system and method for publishing video content across a wired and wireless network in an efficient, expeditious and user-friendly manner.

### SUMMARY OF THE INVENTION

The present invention relates to a system and a method for facilitate the publishing of electronic content between a wireless network and a wired network. As used herein, the term “publishing” is intended to include, but is not limited to, the communication, provisioning, exchange, transfer, and/or the delivery of information, regardless of the format or form of the information. As user herein, the term “electronic content” or “electronic content file” is intended to include, but is not limited to, any electronic file, regardless of type, format, or kind, which may be electrically stored and/or transmitted. Exemplary electronic content includes, but is not limited to, any computer-readable file such as, for example, a video, audio, or composite file.

According to an embodiment of the present invention, a system and method is provided wherein a user may transmit electronic content from his or her wireless device to one or more preconfigured online publishing destinations. As used herein, the term “wireless device” is intended to include, but is not limited to, any device configured to send and/or receive electronic content via wireless network. Exemplary mobile electronic devices include, but are not limited to, a cellular phone, a pager, PDA, smartphone, laptop and any other conventional handheld device.

According to an embodiment of the present invention, the mobile content gateway system is a computer-based system comprising one or more computers configured to facilitate the exchange of electronic content between one or more electronic devices (i.e., a wireless network) and one or more computers on a wired network.

According to an embodiment of the present invention, a method is provided wherein the system and method provide for the automatic ingestion of electronic content via a negotiation with various carriers and/or end device specific services, post processing the video for target publishing platforms if necessary, and automatically delivers the video content to those destination(s).

The present invention intends to greatly simply the necessary steps and technical requirement an end user publisher may have to go through for making video content available across wired and wireless networks. The invention also dramatically reduces the time lapse between the point of content creation (e.g., record a video on a cell phone) to the point of publishing on the desired platform (e.g., show the video on the user's personal home page). Advantageously, according to an embodiment of the present invention, no additional software needs to be installed on the mobile devices, thus providing an extremely light weight and easily adopted solution.

### BRIEF DESCRIPTION OF THE DRAWINGS

The present invention will be more readily understood from the detailed description of preferred embodiments presented below considered in conjunction with the attached drawings, of which:

FIG. 1 illustrates an exemplary process flow for a method of publishing electronic content from a wireless device to a wired network, according to an embodiment of the present invention;

FIG. 2 is an illustration of a Mobile Content Gateway System configured to facilitate the publishing of electronic content from a wireless device to a wired network, according to an embodiment of the present invention;

FIG. 3 illustrates an exemplary process flow for a method of publishing electronic content from a wired network to a wireless device, according to an embodiment of the present invention; and

FIG. 4 is an illustration of a Mobile Content Gateway System configured to facilitate the publishing of electronic content from a wired network to a wireless device, according to an embodiment of the present invention.

It is to be understood that these figures are for purposes of illustrating the concepts of the invention and may not be to scale.

### DETAILED DESCRIPTION OF THE INVENTION

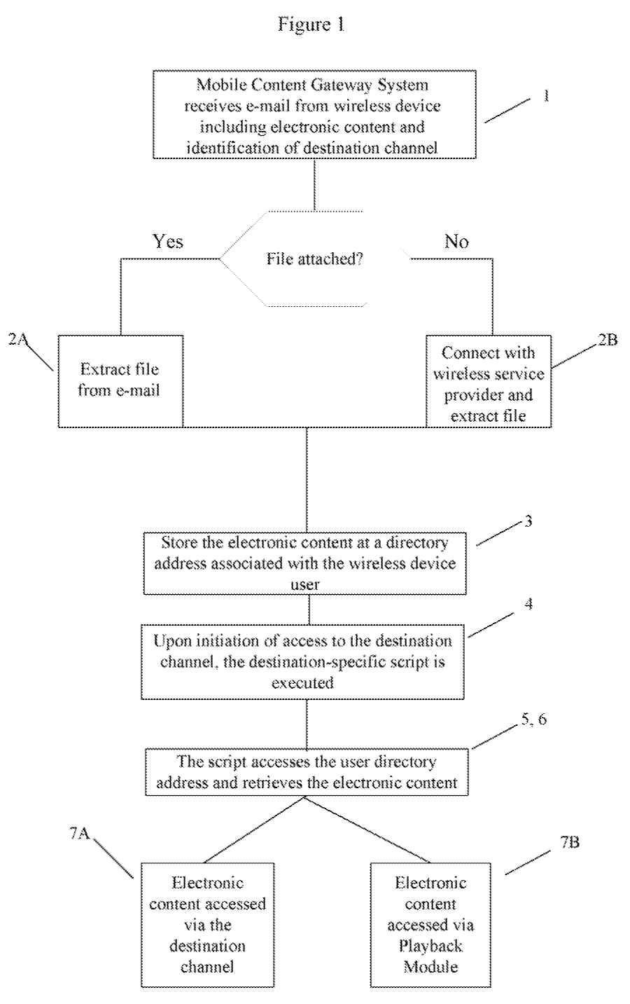

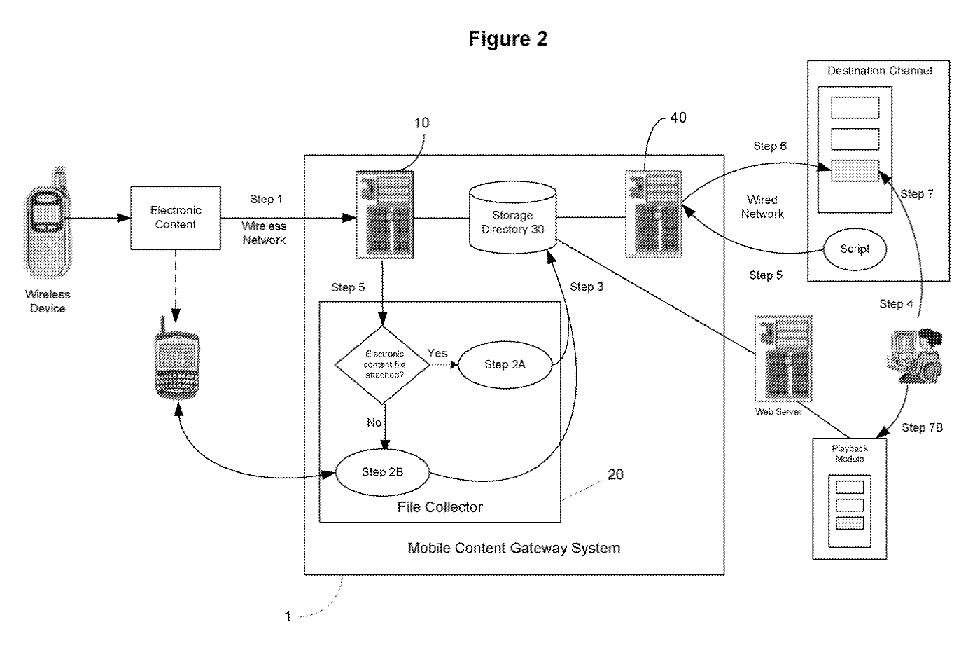

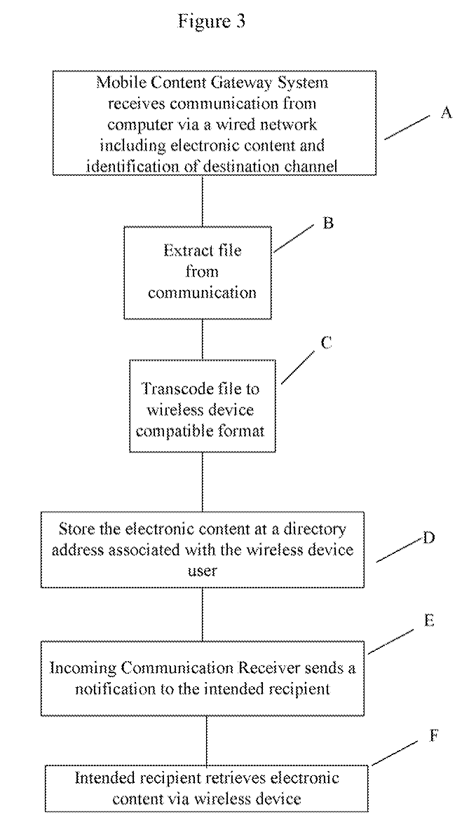

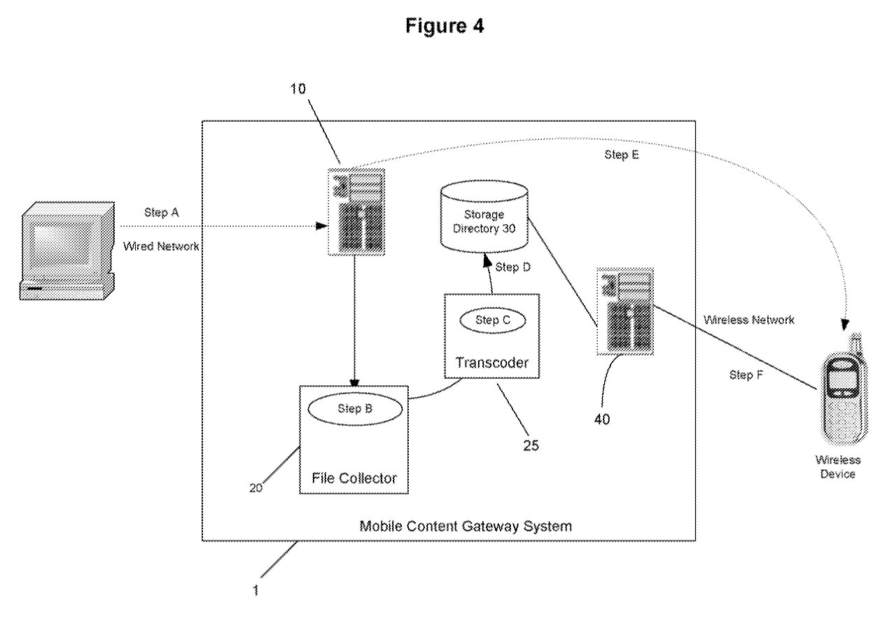

The present invention relates to a system (herein referred to as the “Mobile Content Gateway System”) and method for facilitating the publishing of electronic content between wired and wireless networks. FIG. 1 depicts an exemplary process flow for the publishing of electronic content from a wireless device to a wired network and/or computer, as facilitated by the Mobile Content Gateway system of the present invention. FIG. 2 illustrates an exemplary Mobile Content Gateway System 1 according to an embodiment of the present invention. FIG. 2 further illustrates the steps of the process flow. FIG. 3. In the following description related to FIGS. 1-4, an example is used referred to wherein the user utilizes a mobile phone (the wireless device) to posts a video (the electronic content) created using the phone to his or her myspace.com account (the destination channel) using the Mobile Content Gateway System 1 of the present invention. Furthermore, an example is used to illustrate the method and system shown in FIGS. 3-4 wherein video (the electronic content) created by a user utilizing his or her personal computer (the wired network) is posted to his or her mobile phone (the wireless device and destination channel) using the Mobile Content Gateway System 1 of the present invention. One having ordinary skill in the art will appreciate that this example is presented to illustrate the present invention, and in no way should the present invention be deemed limited to the specific example described herein.

FIGS. 1 and 2 illustrate an exemplary Mobile Content Gateway System 1 according to an embodiment of the present invention. The Mobile Content Gateway System 1 is a computer-based system configured to automatically publish electronic content produced by a wireless device on wireless network (i.e., mobile phone) to a destination channel, such as, for example, a website operating on a wired network (i.e., the Internet) such as, www.myspace.com. The term “computer” is intended to include any data processing device, such as a desktop computer, a laptop computer, a mainframe computer, a personal digital assistant, a server, a handheld device, or any other device able to process data. The electronic content is published or delivered by the wireless device to the destination channel via Mobile Content Gateway System 1, such that the content may be viewed by one or more individuals accessing the wired network (i.e., via a personal computer connected to the Internet).

As shown in FIGS. 2 and 4, the Mobile Content Gateway System 1 of the present invention comprises the following computer-based components: an Incoming Communication Receiver 10, a File Collector 20, a Transcoder 25, a Storage Directory 30, and a File Publisher 40.

According to an embodiment of the present invention, a user may set up an account on the Mobile Content Gateway System 1. In so doing, the user may establish rules on the Mobile Content Gateway System 1 which govern how content uploaded from the user's wireless device is to be published. These rules, herein referred to as “publication rules” may include, for example information related to the one or more destinations to which the user permits publishing of his or her content. For example, a user may establish a publication rule whereby all of the user's content may be published to his or her myspace.com page, a blogging site, a personal homepage, an online forum; or forwarded to one or more e-mail addresses.

For publication rules established by a user which target web properties, the Mobile Content Gateway System 1 generates a destination-specific script and provides same to the user. The destination-specific script comprises a computer-executable program configured to interact with the specified web destination and provide the following functionality: 1) presents the user with a graphic user interface for accessing the published content; 2) grants access from the destination to the Mobile Gateway System 1 for retrieving and rendering the electronic content; and 3) provides a link to a playback module. The user then “cuts and pastes” or otherwise loads the script into his or her destination channel (e.g., his or her myspace.com page).

In addition, for each publication rule, the Mobile Content Gateway System 1 creates a destination-specific address (i.e., an e-mail address). For example, a destination-specific address assigned to a user's myspace.com page may be useramemyspace@mcg.com. It is to be appreciated that the domain name “@mcg.com” is used for illustrative purposes and is intended to represent the address/location of the Mobile Content Gateway System 1. As shown, the destination-specific address includes information related to the user and the destination channel (myspace.com). A destination-specific address may also be presented to the mobile device user in the form of a mobile short code (e.g., a numeric or alphanumeric code, such as 58764), which may be more familiar and easier to remember by the average mobile device user, as compared to a conventional email address. Optionally, the short code may be purchased from a Multimedia Messing Service (MMS) broker and may be mapped to the exact destination email address to which publishing is intended. The Mobile Content Gateway System 1 is configured to store the publication rules for each user and the associated destination-specific addresses created at the request of the user. In addition, the one or more destination-specific addresses created for the user may be provided to the user so that he or she may direct electronic content to the one or more destination channels in the future.

According to an embodiment of the present invention, the user establishes, creates, or identifies the electronic content to be published. One having ordinary skill in the art will appreciate that the user may create the electronic content using the capabilities of the wireless device (e.g., record a video and/or audio clip using a camera/recorder built-in to the wireless device) or, alternatively, the electronic content may have been created elsewhere and subsequently delivered to the wireless device.

Referring to FIGS. 1 and 2, the user prepares and transmits a communication (i.e., an e-mail) including the electronic content and addresses the e-mail to the one or more destination-specific addresses of each of the one or more destination channel(s) to which the user would like the electronic content published. Optionally, the user content may also be transmitted as an MMS message which also takes an e-mail address as the destination. The e-mail or MMS is received by the Incoming Communication Receiver 10 of the Mobile Content Gateway System 1, as shown in step 1. The Incoming Communication Receiver 10 is a computer-based module/program configured to interface with the wired network and wireless network. The Incoming Communications Receiver 10 is further configured to receive the communication which includes the electronic content from the wireless device (as shown in FIG. 2) and the wired network (as shown in FIG. 4).

According to an embodiment of the present invention, the e-mail is transmitted via the wireless device service provider (e.g., the mobile phone carrier). Depending on the wireless device service provider, the electronic content may be attached to the e-mail as a file having any suitable format. Exemplary formats for the file attachment include, but are not limited to .mp4, .jpg, .wav, .3gp, .mp3, .avi, .wmv; and .3g2. Alternatively, the electronic content may be represented by a hyperlink embedded in the e-mail which points to a location where the electronic content is stored.

The Incoming Communication Receiver 10 passes the communication to the communicatively connected File Collector 20. The File Collector 20 is a computer-based program/module configured to process the communication and manage the file including the electronic content according to the description below. One having ordinary skill in the art will appreciate that the Incoming Communication Receiver 10 and the File Collector 20 may be logically configured as a single module adapted to perform the all of the functions described herein in connection with each module.

In the case where the file is attached to the e-mail, the File Collector 20 examines the incoming e-mail, identifies the attachment, and extracts the attached file, as shown in step 2A. In the event the hyperlink is embedded in the e-mail, the File Collector 20 determines that no file is attached and connects to the wireless device service provider's network to retrieve the file, as shown in step 2B. In this example, the user, Jane Doe, elects to send a video file from her cell phone to her myspace.com account. Jane creates the video file using the camera built-in to her cell phone, attaches the video file to an e-mail, and send the e-mail to janedoemyspace@mcg.com, which is the destination-specific address associated with her myspace.com account created by the Mobile Content Gateway System 1 at the time Jane established the associated publication rule.

In step 3, the File Collector 20 sends the electronic content file to the communicatively connected Storage Directory 30, where the electronic content file is stored. The Storage Directory 30 comprises a computer-accessible database or other suitable storage or memory module. The Storage Directory 30 comprises a plurality of storage location (e.g., addresses in a storage directory) each of which may be uniquely assigned to a user (herein referred to as “a user directory address”). The user directory address stores information associated with the specific user of the wireless device captured during the registration process, including, but not limited to, the user's publication rules, the one or more destination-specific addresses, information related to the one or more destination-specific scripts generated on behalf of the user, etc. Advantageously, the electronic content delivered by the user is stored at his or her user directory address with the Mobile Content Gateway System 1 to allow for distribution to the one or more destination channels associated with the one or more publication rules preset by the user. For example, a single copy of all content generated by a particular user may be stored securely in the storage directory. Each publishing rule or destination is then associated with a unique index file that contains the list of content intended for publication on the associated destination channel. The index file is updated whenever new content is received through the corresponding user publishing destination-specific address.

Next, in step 4, when the user's destination channel is accessed (i.e., when a visitor accesses Jane's myspace.com page), the script embedded therein is invoked. The destination-specific script is configured to automatically connects back to the File Publisher 40 of the Mobile Content Gateway System 1. Moreover, the destination-specific script is configured to prompt the File Publisher 40 to access the user directory address and retrieve the electronic content stored to which the destination has been granted access, by virtue of the preset publication rules, as shown in step 5. In this regard, the destination-specific script is configured to retrieve only those files authorized by the user pursuant to his or her publication rules. Although the script is referred to as “destination-specific” one having ordinary skill in the art will appreciate that a single script may be used for and compatible with a plurality of destination channels, depending on the nature and characteristics of the destination channels.

According to an embodiment of the present invention, the script may be configured to retrieve the electronic content by prompting the File Publisher 40 to extract or download the electronic content to the destination channel in any suitable format, such as an executable thumbnail or a hyperlink, as shown in step 6.

According to an embodiment of the present invention, the visitor may access the electronic content via the destination channel, as shown in step 7A. According to another embodiment of the present invention, the script may be configured to retrieve the electronic content by directing the content to a playback module associated with the Mobile Content Gateway System 1. According to this embodiment, the script may then provide the visitor with a link or thumbnail which redirects the visitor to a portal to the playback module configured to display/play the electronic content for the visitor, as shown in step 7B. The playback module may be any suitable computer-based program or application configured to process and present electronic content. For example, the playback module may comprise a web page with embedded any conventional video players, such as, for example, an Apple QuickTime player, a Macromedia Flash player, or a Windows Media Player.

FIGS. 3 and 4 depict an exemplary process flow of the Mobile Content Gateway System 1 configured to publish electronic content from a wired network (e.g., a computer connected to a conventional wired network) to one or more wireless devices, according to an embodiment of the present invention. In step A, a computer delivers a communication including the electronic content via a wired network to the Incoming Communication Receiver 10. The communication further comprises information which identifies the one or more wireless devices which are to receive the electronic content, herein referred to as the “recipient wireless device.” The identifying information, herein referred to as the “recipient wireless device identifier” may include any information related to the wireless device, such as, for example, a wireless device-specific e-mail address or a mobile phone number. The wireless device-specific e-mail address is a unique address assigned to each wireless device registered with the Mobile Content Gateway System 1. For example, a user's mobile phone may be assigned a wireless device-specific e-mail address of mobilephonenumber@mcg.com. As shown, the wireless device-specific address includes information which identifies the intended recipient of the electronic content (i.e., the mobile phone number). One having ordinary skill in the art will appreciate that the communication may be in any suitable format, such as, for example, an e-mail, web posting, and/or a Simple Object Access Protocol (SOAP) communication.

In step B, the File Collector 20 of the Mobile Content Gateway System 1 extracts the electronic content from the communication received from the communicatively connected wired network. Optionally, the communication includes information which identifies the sender, which the File Collector 20 may review to verify that the sender is permitted/authorized to communicate via the Mobile Content Gateway System 1. Depending on the specific communications mechanism selected between the sender and the Mobile Content Gateway System 1, a variety of authorization techniques familiar to one having ordinary skill in the art can be applied. For example, if a sender communicates to the Mobile Content Gateway System 1 via e-mail, any well established email authentication mechanism may be applied. If a sender communicates to the Mobile Content Gateway System 1 using Web Service APIs, any well established Web authentication mechanisms may be applied.

In step C, the file extracted by the File Collector 20 is sent to the communicatively connected Transcoder 25, which comprises a computer-based program/module configured to transcode a file from a format compatible with a wired network to a format compatible with a wireless device. The Transcoder 25 transcodes or re-formats the extracted electronic content file into the universal wireless media file format, i.e., .3gpp. The transcoded file is then directed to the Storage Directory 30 for storage, as shown in step D. The Storage Directory 30 stores the file in a manner which identifies the intended recipient wireless device. For example, if electronic content (e.g., a video file) is intended for receipt by Jane Doe's mobile phone (having a phone number of (123) 555-1234), the file may be stored in the storage directory with a file name of ‘janedoe\1235551234\videofile.3gp”.

In step E, the Incoming Communication Receiver 10 sends a notification to the intended recipient wireless device. The notification may be transmitted in any suitable format, including but not limited to a text message, an e-mail, a phone call, and a SMS communication. According to an embodiment of the present invention, the notification may include, but is not limited to, information related to the sender of the electronic content, a description of the electronic content, instructions regarding the retrieval of the electronic content.

One having ordinary skill in the art will appreciate the step D may be performed either before, during or after the performance of step B (extraction of the file) and/or step C (transcoding and storage of the file).

In step F, having received the notification from the Incoming Communication Receiver, the wireless device may connect to the File Publisher 40 to retrieve the electronic content. The wireless device may playback the electronic content locally using a native program configured to display and/or play the electronic content (e.g., a native video player) or using a standalone player provided by the Mobile Content Gateway System 1. The standalone player may be loaded onto the wireless device during registration or when accessing content via the File Publisher 40.

According to an embodiment of the present invention, the Mobile Video Gateway System 1 may be configured to offer third party systems the ability to deliver electronic content across wireless and wired networks. As compared to the previously described embodiments, the difference in this case is that the sender of the content, instead, of an individual end user, may be an automated computer program running on a third party system's backend. For example, a third party e-mail system may deliver electronic content (e.g., video) down to mobile devices by automatically sending content destined for mobile devices into the Mobile Content Gateway System 1, by following the proper API format published by the Mobile Content Gateway System 1.

It is to be understood that the exemplary embodiments are merely illustrative of the present invention and that many variations of the above-described embodiments can be devised by one skilled in the art without departing from the scope of the invention. It is therefore intended that all such variations be included within the scope of the invention.

What is claimed is:

1. A method for publishing an electronic content file from a wireless device to a destination channel located on a wired network, the method comprising the steps of:
receiving a communication comprising the electronic content file from the wireless device;
extracting the electronic content file;
storing the electronic content file at a directory address associated with the wireless device; and
providing a destination-specific script to the destination channel, wherein the destination-specific script is configured to:
access the directory address associated with the wireless device,
retrieve the electronic content file, and
publish the electronic content file to the destination channel.

2. The method of claim 1, wherein the communication further comprises information identifying the destination channel.

3. The method of claim 1, wherein the electronic content file is extracted from a website identified by a hyperlink included in the communication received from the wireless device.

4. The method of claim 1, further comprising the step of playing the electronic content file.

5. The method of claim 1, wherein the electronic content file comprises video.

6. The method of claim 1, wherein the destination channel comprises a website.

7. The method of claim 1, wherein the communication comprises an e-mail.

8. A method for publishing an electronic content file from a component located on a wired network to a wireless device, the method comprising the steps of:
receiving from the component via the wired network a communication comprising the electronic content file and information identifying the intended recipient wireless device;
extracting the electronic content file;
transcoding the electronic content file into a wireless-compatible format;
storing the transcoded electronic content file at a directory address associated with the intended recipient wireless device;
providing the intended recipient wireless device with notice that the electronic content file is available; and
publishing the electronic content file to the intended recipient wireless device.

9. The method of claim 8, wherein the publishing step comprises allowing the wireless device to retrieve the electronic content file for playback using a native player.

10. The method of claim 8, further comprising the step of providing the wireless device with a player capable of playing the electronic content file.

11. The method of claim 10, wherein the publishing step comprises allowing the wireless device to retrieve the electronic content file for playback using the player.

12. The method of claim 8, wherein the communication further comprises information identifying the destination channel.

13. The method of claim 8, wherein the electronic content file is extracted from a website identified by a hyperlink included in the communication received from the wireless device.

14. The method of claim 8, wherein the electronic content file comprises video.

15. The method of claim 8, wherein the communication comprises an e-mail.

16. The method of claim 8, wherein the step of providing notice to the wireless device comprises transmitting an e-mail to the wireless device.

17. The method of claim 8, wherein the step of providing notice to the wireless device comprises transmitting a text message to the wireless device.

18. A system for publishing an electronic content file from a wireless device to a destination channel located on a wired network, the method comprising the steps of:
an incoming communication receiver configured to receive a communication comprising the electronic content file from the wireless device;
a file collector configured to extract the electronic content file from the communication provided by the communicatively connected incoming communication receiver;
a directory configured to receive the extracted electronic content file from the file collector and store the extracted electronic content file at an address associated with the wireless device; and
a file publisher configured to provide a destination-specific script to the communicatively connected destination channel, wherein the destination-specific script is configured to:
access the directory address associated with the wireless device,
retrieve the electronic content file, and
publish the electronic content file to the destination channel.

19. A system for publishing an electronic content file from a component located on a wired network to an intended recipient wireless device comprising:
an incoming communication receiver configured to:
receive a communication comprising the electronic content file from the component via the wired network; and
provide the intended recipient wireless device with notice that the electronic content file is available;
a file collector configured to extract the electronic content file from the communication provided by the communicatively connected incoming communication receiver;
a transcoder configured to transcode the electronic content file into a wireless-compatible format;
a directory configured to receive the transcoded electronic content file from the transcoder and store the transcoded electronic content file at an address associated with the intended recipient wireless device; and
a file publisher configured to publish the electronic content file to the intended recipient wireless device.
